(19) United States
(12) Patent Application Publication
(10) Pub. No.: US 2024/0294178 A1
(43) Pub. Date: Sep. 5, 2024

(54) DEVICE AND METHOD FOR CHECKING THE PLAUSIBILITY OF MEASURED VALUES OF AN ONBOARD AXLE LOAD MEASURING SYSTEM

(71) Applicant: ZF CV Systems Europe BV, Brussels (BE)

(72) Inventors: Thomas Dieckmann, Pattensen (DE); Arne Ehlers, Hannover (DE); Ralph-Carsten Lülfing, Garbsen (DE); Janik Ricke, Uetze (DE)

(21) Appl. No.: 18/646,377

(22) Filed: Apr. 25, 2024

Related U.S. Application Data
(63) Continuation of application No. PCT/EP2022/076568, filed on Sep. 23, 2022.

(30) Foreign Application Priority Data
Oct. 25, 2021 (DE) 10 2021 127 654.3

(51) Int. Cl. B60W 50/02; B60W 40/13; B60W 50/14; B60W 50/16; H04W 4/40

(52) U.S. Cl. CPC B60W 50/0205; B60W 40/13; B60W 50/16; H04W 4/40; B60W 2050/021; B60W 2050/143; B60W 2050/146; B60W 2520/105; B60W 2530/10; B60W 2556/45

(57) ABSTRACT

A device is for checking the plausibility of measured values of an axle load measuring system determinable via a sensor system, using which the axle load resting on all axles of a vehicle is determinable as a first total axle load value. The device has a comparator and a computing unit. A second total axle load value is computable via the computing unit. The first and the second total axle load value can be supplied to the comparator, a comparison between the two total axle load values can be carried out via the comparator, and, if there is a sufficiently large difference between the first total axle load value and the second total axle load value, an error message can be generated and/or a signal generator can be activated via the comparator. Manipulations and measurement errors on the axle load measuring system may be recognized in this way.

### CROSS-REFERENCE TO RELATED APPLICATIONS

This application is a continuation application of international patent application PCT/EP2022/076568, filed Sep. 23, 2022, designating the United States and claiming priority from German application 10 2021 127 654.3, filed Oct. 25, 2021, and the entire content of both applications is incorporated herein by reference.

### TECHNICAL FIELD

The disclosure relates to a device for checking the plausibility of measured values of an axle load measuring system determinable via a sensor system, using which the axle load resting on all axes of a vehicle is determinable as a first total axle load value. In addition, the disclosure relates to a method for operating this device.

### BACKGROUND

It is already known that brake force regulators in wheeled vehicles take into consideration the current axle load of a vehicle to be decelerated. To measure an axle load acting on a vehicle axle, articulating a component of a chassis via a coupling rod with a stabilizer of a vehicle axle is known from EP 2 554 409 B1. The coupling rod is connected at each of its two ends to an eccentric, via which the coupling rod is rotatably linked on the stabilizer and the chassis. Upon loading of the vehicle, the distance decreases between the component of the chassis and the component of the axle, wherein this distance change is transformed into a proportional pivot movement of the eccentric. These pivot movements are measurable via a rotational angle sensor, which generates a measurement signal proportional to the pivot therefrom. The load-related axle load on the vehicle axle may be calculated from this measurement signal with quite high accuracy. Such axle load measuring systems have the disadvantage of the low level of security from manipulation of the described mechanical coupling. Moreover, in such axle load measuring systems, the rotational angle sensor is susceptible to wear due to adverse environmental influences in the area of the vehicle underbody.

A device for determining the deflection level on a vehicle sprung via air spring bellows and damped via shock absorbers is known from DE 38 21 569 A1. In this device, a linear displacement sensor is integrated directly into a shock absorber of the vehicle to ascertain a load-related deflection level of the vehicle. In this way, a high level of manipulation security and functional reliability of the sensor with respect to adverse environmental influences in the area of the vehicle underbody is provided. However, it is a disadvantage that specially configured shock absorbers are required to measure a load-related deflection level.

A vehicle information system having an integrated event recorder is known from WO 02/03346 A1. According to one embodiment, this vehicle information system has a housing having a manipulation-proof seal, which is not detachable without being destroyed. The housing can thus be opened exclusively by authorized personnel using passwords. The vehicle information system has multiple sensor units in the area of the springs, the axles, and/or the chassis of a truck, which can be implemented using strain gauges, for example. The sensor units are configured to measure distance differences between the mentioned vehicle components, which arise due to the forces acting on these components. Accordingly, this vehicle information system uses a conventional, onboard sensor system, which is not reliably protected from unauthorized access, however.

### SUMMARY

It is an object of the disclosure to provide a device and a method, using which, upon use of a conventional onboard axle load measuring system of a vehicle, its measurement reliability is improved in order to avoid measurement errors, which can arise due to impermissible manipulations and/or appearances of wear on the axle load measuring system.

The object with respect to the device can, for example, be achieved by a device for checking the plausibility of measured values of a conventional onboard axle load measuring system of a vehicle determinable via a sensor system, wherein the axle load resting on all axles of a vehicle is determinable as a first total axle load value (G_{A1}) using the axle load measuring system. The device includes: a comparator; a computing unit; the computing unit being configured to compute a second total axle load value (G_{A2}); the comparator being configured to have the first total axle load value (G_{A1}) and the second total axle load value (G_{A2}) supplied thereto; the comparator being configured to carry out a comparison between the first total axle load value (G_{A1}) and the second total axle load value (G_{A2}); and, the comparator being configured, if there is a sufficiently large difference (ΔG) between the first total axle load value (G_{A1}) and the second total axle load value (G_{A2}), to at least one of generate an error message and activate a signal generator.

The aforementioned object can, for example, further be achieved via a device for checking the plausibility of measured values of an axle load measuring system determinable via a sensor system, wherein the axle load resting on all axles of a vehicle is determinable as a first total axle load value (G_{A1}) using the axle load measuring system. The device includes: a comparator; a computing unit; the computing unit being configured to compute a first vehicle mass value (m₁) by addition of the first total axle load value (G_{A1}) and a value of a total mass (m_{FA}) of all vehicle axles (m₁=G_{A1}+m_{FA}), the computing unit being configured to compute a second vehicle mass value (m₂) including cargo computable via the computing unit from values of a vehicle acceleration (a) and a drive force (F) acting on the vehicle as well as a formula m=F/a; the comparator being configured to have the first vehicle mass value (m₁) and the second vehicle mass value (m₂) supplied thereto and to carry out a comparison between the first vehicle mass value (m₁) and the second vehicle mass value (m₂); and, the comparator being further configured, if there is a sufficiently large difference (ΔG) between the first vehicle mass value (m₁) and the second vehicle mass value (m₂), to at least one of generate an error message and activate a signal generator.

The aforementioned object can, for example, further be achieved via a method for checking the plausibility of measured values of an axle load measuring system determinable via a sensor system, using which the axle load resting on all axles of a vehicle is determinable as a first total axle load value (G_{A1}), having the following method steps: a) determining a first total axle load value (G_{A1}), which indicates a measured value of a mass that rests on all vehicle axles; b) calculating a vehicle total mass (m) including cargo using the formula m=F/a, wherein the value (a) stands for the current vehicle acceleration and the value (F) stands for the drive force currently acting on the vehicle; c) calculating a second total axle load value using the formula G_{A2}=(F/a)−m_{FA}, wherein the value m_{FA} stands for the total mass of all considered vehicle axles; d) comparing the first total axle load value (G_{A1}) and the second total axle load value (G_{A2}); and, e) generating an error message if a sufficiently large difference (ΔG) is established between the first total axle load value (G_{A1}) and the second total axle load value (G_{A2}).

The aforementioned object can, for example, further be achieved by a method for checking the plausibility of measured values of an axle load measuring system determinable via a sensor system, using which the axle load resting on all axles of a vehicle is determinable as a first total axle load value (G_{A1}), the method comprising: f) determining a first total axle load value (G_{A1}), which indicates the measured value of a mass that rests on all vehicle axles; g) calculating a first vehicle mass value (m₁) including cargo by adding the first total axle load value (G_{A1}) to a value (m_{FA}) for a total mass of all considered vehicle axles; h) calculating a second vehicle mass value (m₂) including cargo using the formula m=F/a, wherein the value (a) stands for the current vehicle acceleration and the value (F) stands for the drive force currently acting on the vehicle; i) comparing the first vehicle mass value (m₁) and the second vehicle mass value (m₂); and, j) generating an error message if a sufficiently large difference (ΔG) is established between the first vehicle mass value (m₁) and the second vehicle mass value (m₂).

Accordingly, the disclosure primarily relates to a device for checking the plausibility of measured values of an axle load measuring system determinable via a sensor system, using which the axle load resting on all axles of a vehicle is determinable as a first total axle load value G_{A1}. The vehicle can be, for example, a wheeled vehicle configured as a passenger vehicle or utility vehicle.

To achieve the mentioned object, it is provided in this device that the device has a comparator and a computing unit, a second total axle load value G_{A2} is computable via the computing unit, the first total axle load value G_{A1} and the second total axle load value G_{A2} can be supplied to the comparator, a comparison between the two total axle load values G_{A1}, G_{A2} can be carried out via the comparator, and an error message can be generated and/or a signal generator can be activated via the comparator if there is a sufficiently large difference ΔG between the first total axle load value G_{A1} and the second total axle load value G_{A2}.

The device is accordingly configured such that it can compare these two total axle load values G_{A1}, G_{A2} to one another, of which the first total axle load value G_{A1} is determinable relatively accurately by sensory measurements, while the second total axle load value G_{A2} is determinable somewhat less accurately. To determine the first total axle load value G_{A1}, for example, only one pressure sensor per air spring bellows of an air spring device on the vehicle and thus the use of only one measuring principle is necessary. To calculate the second total axle load value G_{A2}, for example, the current output torque of a drive motor of the vehicle and the current vehicle acceleration are required, because of which the use of at least two measuring principles is necessary for this purpose, which causes a somewhat less accurate determination of the second total axle load value G_{A2}.

The device is configured so that if there is a sufficiently large difference ΔG between the first total axle load value G_{A1} and the second total axle load value G_{A2}, an error message can be output, which is to prompt checking the measurement system.

According to an advantageous embodiment of the device according to the disclosure, it is provided as already indicated that the computing unit can be supplied with the current value of the vehicle acceleration a and the current value of the drive force F acting on the vehicle, the vehicle total mass m including cargo is computable via the computing unit from the values of the vehicle acceleration a and the drive force F acting on the vehicle as well as the formula m=F/a, and from this value of the vehicle total mass m minus the total mass m_{FA} of all vehicle axles, the second total axle load value G_{A2} is computable [G_{A2}=(F/a)−m_{FA}].

The value of the force F required for determining the total mass m resting on all vehicle axles via the formula m=F/a may be established via the torque of the drive motor of the vehicle. The torque M of the drive motor can be retrieved in modern vehicles without problems via CAN bus in real time from the onboard computer, so that if the length of the active lever arm r is known, in particular in the form of half the diameter of an output shaft, the force is computable according to the equation M=F·r or F=M/r.

The device according to the disclosure therefore enables with a certain inaccuracy the calculation of the second total axle load value G_{A2} via sensors which are not associated with the axle load measuring system. The sensors used for this purpose are an acceleration sensor, using which the acceleration a of the vehicle in the vehicle longitudinal direction is measurable, and a sensor using which the drive force currently active on the vehicle is measurable directly or indirectly. Via a second total axle load value G_{A2} calculated in this way, a first total axle load value G_{A1} can be checked with respect to its plausibility, which is determinable with a higher accuracy via the axle load measuring system present in the vehicle, but is possibly falsified. If the first total axle load value G_{A1} and the second total axle load value G_{A2} correspond within specified tolerance values, it can be presumed that the first total axle load value G_{A1} determined by the onboard axle load measuring system is correct.

However, if the first total axle load value G_{A1} determined by the onboard axle load measuring system has a greater difference from the somewhat less accurately calculated second total axle load value G_{A2}, this could indicate a manipulation, an error, a defect, wear, or the like on the sensor system of the onboard axle load measuring system and could therefore be reliably detected and remedied at once.

The accurate axle load values for each vehicle axle can supply items of information helpful for further safety devices of the vehicle, such as an electronic stability program, for example, a center of gravity location of the vehicle changed by improper loading. The total axle load or summation axle load of the vehicle is composed in this case of the sum of the individual axle loads of the vehicle axles and is typically specified by the axle load measuring system as a mass having the mass unit kilograms (kg) or as a force having the mass unit newtons (N).

The disclosure also relates to a variant of the device just described. This device is also used to check the plausibility of measured values of an axle load measuring system determined via a sensor system, using which the axle load resting on all axles of a vehicle is determinable as a first total axle load value G_{A1}.

This device is characterized in that it has a comparator and a computing unit, a first vehicle mass value m₁ is calculable via the computing unit by addition of the first total axle load value G_{A1} and the value of the total mass m_{FA} of all vehicle axles (m₁=G_{A1}+m_{FA}), a second vehicle mass value m₂ including cargo is calculable via the computing unit from the values of the vehicle acceleration a and the drive force F acting on the vehicle as well as the formula m=F/a, the first vehicle mass value m₁ and the second vehicle mass value m₂ can be supplied to the comparator, a comparison between the two vehicle mass values m₁, m₂ can be carried out via the comparator, and if there is a sufficiently large difference ΔG between the first vehicle mass value m₁ and the second vehicle mass value m₂, an error message can be generated and/or a signal generator can be activated via the comparator.

Accordingly, this device variant is configured and provided to determine the vehicle mass m₁, m₂ including cargo mass two times and in different ways, and then to compare these values. If there is an excessively large deviation of these values from one another, an error message can be output by the device, which recommends a check of the sensor system of the axle load measuring system.

According to a first embodiment of the described devices, it is provided that the device has an optical, acoustic, and/or haptic signal generator to output an error message.

Furthermore, it can preferably be provided that the device has a wirelessly operating transmitting and receiving unit, via which the error message is transmittable to a wirelessly operating stationary transmitting and receiving unit, which is connected to a vehicle-external computer. The error message is processable in this vehicle-external computer and, for example, displayable on a display device.

Moreover, it is considered to be advantageous if it is provided that the comparator is connected to an event memory, in which such error messages are storable and from which the error messages are retrievable again.

To achieve the object with respect to the method, a method for checking the plausibility of measured values of an axle load measuring system determinable via a sensor system, using which the axle load resting on all axles of a vehicle is determinable as a first total axle load value G_{A1}. This method has the following method steps:
a) determining a first total axle load value G_{A1}, which indicates the measured value of the mass that rests on all vehicle axles,
b) calculating the vehicle total mass m including cargo using the formula m=F/a, wherein the value a stands for the current vehicle acceleration and the value F stands for the drive force currently acting on the vehicle,
c) calculating a second total axle load value G_{A2} using the formula G_{A2}=(F/a)−m_{FA}, wherein the value m_{FA} stands for the total mass of all vehicle axles taken into consideration,
d) comparing the two total axle load values G_{A1}, G_{A2}, and
e) generating an error message if a sufficiently large difference ΔG is established between the first total axle load value G_{A1} and the second total axle load value G_{A2}.

Accordingly, a first total axle load value G_{A1}, which is determinable more accurately as such, is determined on the basis of measured values of an axle load measuring system. To check the correctness of the first total axle load value G_{A1}, a second total axle load value G_{A2} is determined by a calculation, which provides a somewhat less accurate result. To calculate the second total axle load value G_{A2}, first the vehicle total mass m is determined, which also includes the mass of the chassis of all wheel axles of the vehicle. This vehicle total mass m is calculated using the formula m=F/a, wherein the value of the drive force F acting on the vehicle is determined from the current value of the torque M of the drive motor of the vehicle. The torque M of the drive motor can be retrieved in modern vehicles without problems via CAN bus in real time from the onboard computer, so that if the length of the active lever arm r is known, in particular in the form of half the diameter of an output shaft of the drive motor, the force F is computable according to the equation M=F·r or F=M/r. The acceleration a of the vehicle in the vehicle longitudinal direction is determined via an acceleration sensor. Values of acceleration sensors are also available ready for retrieval in modern vehicles in the CAN bus.

After the vehicle total mass m has been determined via the formula m=F/a, only the value for the total mass m_{FA} of all chassis parts of the vehicle still has to be subtracted from its value. This value, which is constant as such, is stored in a memory of the axle load measuring system or in the mentioned comparator and is retrievable therefrom. The second total axle load value G_{A2} is then determinable using the formula G_{A2}=(F/a)−m_{FA}, wherein the value m_{FA} stands for the total mass of all chassis parts of the vehicle axles.

Since now two values are available for the total axle load of the vehicle, it can be checked by a comparison of the first total axle load value G_{A1}, which is determined more accurately as such, to the rather less accurate second total axle load value G_{A2} whether the first total axle load value G_{A1} is plausible or whether a measurement error or even a manipulation of the axle load measuring system is to be assumed. If a sufficiently large difference ΔG between the first total axle load value G_{A1} and the second total axle load value G_{A2} is established upon this comparison, the first total axle load value G_{A1} is recognized as not plausible and an error message is generated.

The error message is output in this case, for example, as an optical, acoustic, and/or haptic signal. In this way, clear and unmistakably perceptible information about a possible manipulation on the onboard axle load measuring system and/or an error in the calculation of the second total axle load value is possible in real time for a user or a driver of the vehicle. In addition, the user is informed at all times about a loading state of the vehicle. The haptic signal generator can be implemented, for example, via a vibration motor or the like.

However, the error message can also be wirelessly transmitted to a vehicle-external computer. In this way, for example, an external fleet management system, a supply office, a fleet headquarters, or the like can be informed in real time about a suspicion of manipulation or another error.

Moreover, it can be provided that the error message is stored in an event memory of the vehicle, so that it can be printed later, for example, in an error list. As a consequence, extensive possibilities for documentation and diagnosis result.

The stated object with respect to the method is moreover achieved via a method variant. This method is also used to check the plausibility of measured values of an axle load measuring system determinable via a sensor system, using which the axle load resting on all axles of a vehicle is determinable as a first total axle load value G_{A1}, and which is operated with the aid of a device having the above-described features.

This method variant has the following method steps:
f) determining a first total axle load value G_{A1}, which indicates the measured value of the mass that rests on all vehicle axles,
g) calculating a first vehicle mass value m₁ including cargo by addition of the first total axle load value G_{A1} to the value m_{FA} for the total mass of all vehicle axles taken into consideration,
h) calculating a second vehicle mass value m₂ including cargo using the formula m=F/a, wherein the value a stands for the current vehicle acceleration and the value F stands for the drive force currently acting on the vehicle,
i) comparing the two vehicle mass values m₁, m₂, and
j) generating an error message if a sufficiently large difference ΔG is established between the first vehicle mass value m₁ and the second vehicle mass value m₂.

Accordingly, in this method variant two vehicle mass values m₁, m₂ determined on the basis of different data are compared to one another. These vehicle mass values m₁, m₂ describe the complete vehicle mass, thus the mass or the weight of the complete vehicle 18 plus its current cargo. If there is a sufficiently large difference ΔG between the first vehicle mass value m₁ and the second vehicle mass value m₂, an error message can be output, which is to prompt a check of the measuring system.

According to one embodiment, it is provided that a first error interval ΔF₁ of at most ±5% is assigned to the first total axle load value G_{A1} or the first vehicle mass value m₁ with respect to its determination accuracy and a second error interval ΔF₂ of at most ±10% is assigned to the second total axle load value G_{A2} or the second vehicle mass value m₂. In this way, the measurement uncertainties of the onboard axle load measuring system and the calculation are adequately dimensioned. Error intervals deviating therefrom, in particular narrower error intervals, are also possible.

Furthermore, it can be provided that upon a plausibility check of the first total axle load value G_{A1}, an error message is output if the first total axle load value G_{A1} or the first vehicle mass value m₁ is outside the second error interval ΔF₂. In this way, a plausibility check of the axle loads measured by the onboard axle load measuring system is provided, so that any manipulations, wear, or other errors are recognizable.

Another embodiment of the method provides that upon a plausibility check of the second total axle load value G_{A2} or the second vehicle mass value m₂, an error message is output if the second total axle load value G_{A2} or the second vehicle mass value m₂ is outside a third, even greater error interval ΔF₃, with, for example, ΔF₃=ΔF₁±10%. In this way, a check of the axle load values obtained via the somewhat less accurate calculation method is implementable with the aid of the more precise onboard axle load measuring system, for example, for an onboard diagnosis.

Finally, it can be provided in this context that the third error interval ΔF₃ is calculated from the first error interval ΔF₁ plus the percentage value of the second error interval ΔF₂. In this way, a third error interval suitable for the different measurement inaccuracies of the measurement methods is provided.

### BRIEF DESCRIPTION OF DRAWINGS

The invention will now be described with reference to the drawings wherein:

FIG. 1 shows a simplified block diagram of a device having the features of the disclosure; and,

FIG. 2 shows a graphic representation of error intervals for a plausibility determination of a measured total axle load value.

### DETAILED DESCRIPTION

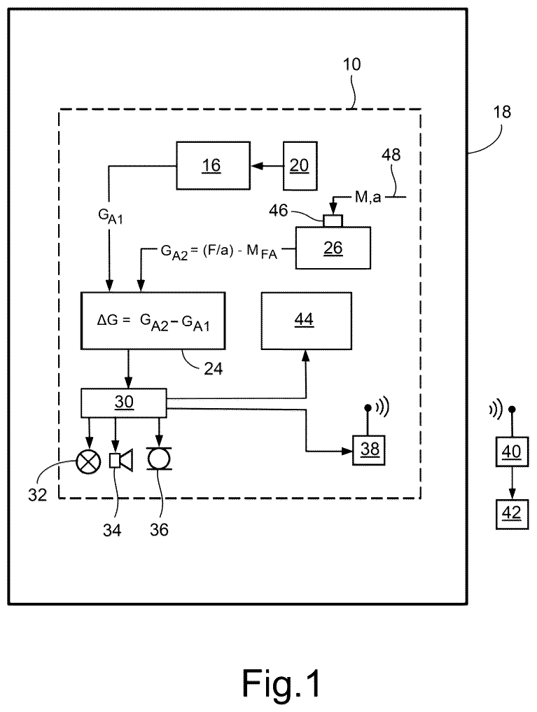

The device 10 shown in FIG. 1 for checking the plausibility of measured values of an onboard axle load measuring system 16 of a vehicle 18, which is known as such, can be integrated, for example, into a brake control unit of a motor vehicle. The components mentioned hereinafter can be integrated here as circuits and/or as software modules into the brake control unit.

The device 10 first has a comparator 24 and a computing unit 26. The vehicle 18 can be, for example, a passenger vehicle, a truck, a tractor, a semitrailer and/or a trailer vehicle. The term vehicle is also understood as a tractor having a semitrailer and a truck having at least one trailer vehicle.

Via the mentioned onboard and conventionally configured axle load measuring system 16, a first total axle load value G_{A1} is determinable with the aid of an assigned sensor system 20 by measurements. This first total axle load value G_{A1} is formed as a function of a number of the axles of the vehicle and is therefore additively composed of the sum of the axle load measured values of the individual axles. This first total axle load value G_{A1} determined by the axle load measuring system 16 can be output and/or temporarily stored, for example, as a mass in the mass unit kilograms (kg) and/or as a force in the mass unit newtons (N).

In a vehicle 18 having an electronically controlled pneumatic suspension, the determination of the total axle load of the vehicle can be carried out, for example, by measuring the air pressures in the individual air spring bellows. The load or force acting on the respective air spring bellows may be calculated in a known manner via the air pressure values. Alternatively thereto, the total axle load of the vehicle can be determined by measuring the load-related different deflection distances of the vehicle chassis in relation to the vehicle axles with the aid of displacement sensors or rotational angle sensors. For this purpose, for example, a transmission linkage for the mechanical coupling between the respective vehicle axle and the vehicle chassis is used, on which such a sensor is arranged. Upon loading of the vehicle, the vehicle chassis moves in the direction toward the vehicle axle, by which the transmission linkage is deflected. This deflection is measurable via the mentioned displacement sensor or rotational angle sensor and convertible into a force or axle load. In this way, the conventionally configured axle load measuring system 16 determines the respective axle loads on each vehicle axle and the first total axle load value G_{A1} as the sum of these axle loads.

A second total axle load value G_{A2} is determinable via the computing unit 26. For this purpose, the total mass m of the vehicle 18 is first calculated by the computing unit 26 using the formula F=m·a or m=F/a. The value of a current acceleration a of the vehicle is retrievable, in addition to a variety of other vehicle-dynamic data such as route, speed, drive torque, slope, and weather conditions, in modern vehicles without problems via the CAN bus 48 from an onboard computer by the computing unit 26. The value of the drive force F acting on the vehicle 18 can be determined by the computing unit 26 from the current value of the torque M of an output shaft of the drive motor of the vehicle 18. The value of the current torque M of the drive motor can also be retrieved via CAN bus 48 from the onboard computer of the vehicle 18, so that if the length of the active lever arm r is known, in particular in the form of half the diameter of the output shaft of the drive motor, the force F is computable according to the formula M=F·r or F=M/r. The total mass m of the vehicle 18 is therefore indirectly determinable at any time by the computing unit 26 at least during the journey of the vehicle 18. The total mass m_{FA} of all vehicle axles is then subtracted from this total mass m of the vehicle 18 and a second total axle load value G_{A2} is thus calculated.

The metrologically determined first total axle load value G_{A1} and the indirectly determined second total axle load value G_{A2} are then compared to one another in the comparator 24. In this comparison, the two total axle load values G_{A1}, G_{A2} are subjected to a subtraction, so that a value is obtained as the difference ΔG, which indicates how strongly these two total axle load values G_{A1}, G_{A2} differ from one another. A sufficiently large difference ΔG between the two total axle load values G_{A1}, G_{A2} is assessed as an indication of a possible manipulation or a systematic measurement error of the comparator 24 an error message 30.

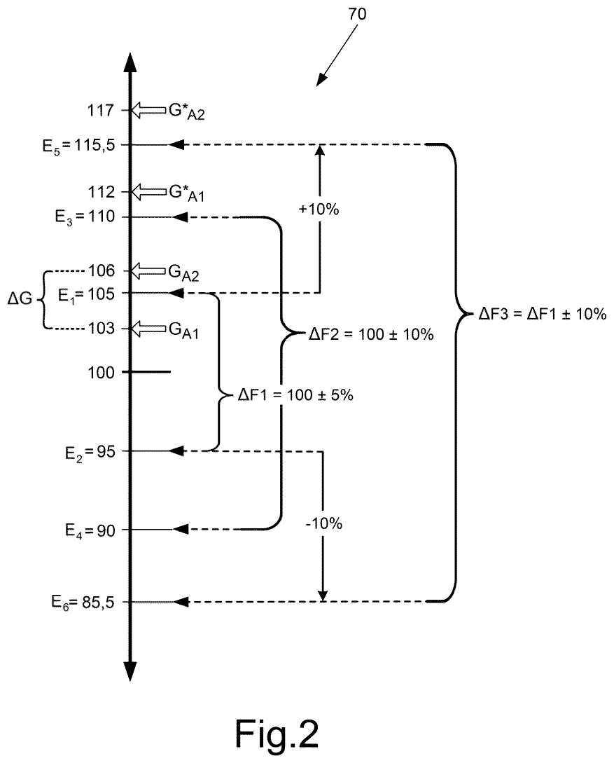

The device 10 can primarily be used to perform a plausibility check of the first total axle load value G_{A1}, which is supplied by the onboard, actually sufficiently accurate axle load measuring system 16, on the basis of the second total axle load value G_{A2}. In such a constellation, an error message 30 or an error signal is output by the comparator 24 if the first total axle load value is outside the second error interval ΔF₂. This is illustrated in FIG. 2 by the total axle load value G*_{A1}=112 marked by an asterisk (*).

The presence of an error message 30 indicates that an impermissible manipulation of the onboard axle load measuring system 16, a defect, or the like is present. An impermissible manipulation can be carried out, for example, by the deformation of a transmission linkage or the provision of a pressure reducer on a pressure sensor of an air spring of an axle load measuring system of an air-sprung vehicle. In addition, wear-related defects, environmental influences, or software errors can occur, which result in systematic measurement errors or evaluation errors.

Vice versa, the device 10 can also be used to check the calculated second total axle load value G_{A2} via the first total axle load value G_{A1}, which is measured by the onboard axle load measuring system 16, which is generally more accurate. In such a constellation, an error message 30 is output if the second total axle load value G_{A2} is outside a third error interval ΔF₃. This is illustrated in FIG. 2 by the total axle load value G*_{A2}=117 marked by an asterisk (*) as erroneous. The value of this third error interval ΔF₃ is calculated from the value of the first error interval ΔF₁ plus the value of the second error interval ΔF₂. It is (±5%)+(±10%)=±15%. With respect to the further details of the error intervals ΔF₁, ΔF₂, ΔF₃, which are only mentioned briefly here, as limiting values for the output of an error message 30 by the device 10, reference is made to the more extensive description of FIG. 2 still following.

The mentioned error message 30 can preferably be displayed via an optical signal generator 32, such as a signal LED or a notification symbol on a display of the vehicle or an electronic mobile device, to at least one user or driver of the vehicle 18. Alternatively or additionally thereto, an acoustic signal generator 34, such as a loudspeaker or piezoelectric buzzer, and/or a haptic signal generator 36, such as a vibration motor, an eccentric, a vibrator, or the like can be provided. The haptic signal generator 36 can be integrated into a driver's seat, into the steering wheel, a gear selection lever, or the like in order to make continuing to drive unpleasant for the user in the most intuitively perceptible manner if there is a pending error message 30.

In addition, the error message 30 can be transmittable via a preferably wireless transmitting and receiving unit 38 via a vehicle-external transmitting and receiving unit 40 to a vehicle-external computer 42. It is thus possible, for example, to transmit the error message 30 to a central fleet management system, a supply office of a shipping company, a fleet management system, or the like. This can also be carried out by a so-called silent alarm without knowledge of the user of the vehicle 18. The wireless transmitting and receiving unit 38 can use a radio standard having the greatest possible range and area coverage, such as mobile wireless, satellite radio, or the like, to enable a geographically extensive forwarding of the error message 30.

In the receiving mode of the vehicle-bound transmitting and receiving unit 38, it can receive a control signal transmitted by the stationary transmitting and receiving unit 40 in order, for example, to obstruct or prevent entirely the continued driving of the vehicle 18 if there is still a pending error message 30 relating to the axle load measuring system 16, similarly to a vehicle immobilizer.

In addition, the device 10 has a manipulation-proof event memory 44, in which the at least one error message 30 is permanently storable. The event memory 44 can only be read out by authorized persons on the occasion of a safety check, maintenance, a police traffic control, a customs control, or the like. The event memory 44 can moreover also contain, in addition to vehicle data, such as the total axle load value, individual axle load values, route, speed, acceleration, drive power, torque, slope of the route, height profile of the route, weather data including air pressure, traffic data, and a position, such as a GPS position, of the vehicle 18 and more extensive items of information. These data are preferably stored in the event memory 44 at uniform time intervals each having an assigned electronic timestamp and date stamp.

In order to enable the readout of the event memory 44, it is equipped with a suitable universal interface 46 for a CAN bus 48 and/or a bidirectional wireless interface, such as Bluetooth®, et cetera. Among other things, all data stored in the event memory 44 can be read out by an authorized person via this interface 46 with the aid of a suitable read device. The data in the event memory 44 are reliably secured against manipulations and unauthorized access, preferably by an encryption and/or a password. Moreover, the event memory 44 is mechanically secured against accidents and power failure, thus configured as crashproof.

The comparator 24, the computing unit 26, the event memory 44, and the vehicle-bound transmitting and receiving unit 38 of the device 10, which are preferably configured in combined form, can possibly each be configured as hardware and/or software components of the onboard computer of the vehicle 18 (not shown) or the onboard axle load measuring system 16.

FIG. 2 illustrates, in a graphic representation 70 on the basis of a numeric value of 100, selected solely as an example, the relative location and the size of the three abovementioned error intervals ΔF₁, ΔF₂, ΔF₃. The term percentage value in the context of the example selected here is either at most ±5% or at most ±15%. The error intervals ΔF₁, ΔF₂, ΔF₃ can possibly be reduced to a percentage value down to ±0.1%, which corresponds in a vehicle 10 having a total mass of 40000 kg to a measurement uncertainty of approximately ±40 kg.

The first error interval ΔF₁ of the first total axle load value G_{A1} determined by sensory measurement, having a percentage value of at most ±5%, extends from an upper end value E₁=105 to a lower end value E₂=95. The second error interval ΔF₂ of the second total axle load value ΔG_{A2} determined indirectly by calculation, having a percentage value of at most ±10%, extends starting from an upper end value E₃=110 to a lower end value E₄=90, each including the end values E₁, . . . , E₄ or including the limits of the respective error intervals ΔF₁, ΔF₂. The third error interval ΔF₃ results from the first error interval ΔF₁ plus the percentage value of at most ±10% of the second error interval ΔF₂. Accordingly, the upper end value E₅ of the third error interval ΔF₃ is, according to the relationship E₅=E₁ (105)+10%=115.5. The lower end value E₆ of the third error interval ΔF₃ is therefore, according to the relationship E₆=E₂ (95)−10%=85.5.

In a first plausibility check of the values of the onboard axle load measuring system 16, the device 10, using the numeric values solely listed here as examples, does not output an error message, because the first total axle load value G_{A1} determined via sensory measurements is within the first error interval ΔF₁ and the indirectly determined second total axle load value G_{A2} is within the second error interval ΔF₂. This is represented in FIG. 2 by the first total axle load value G_{A1}=103 and the second total axle load value G_{A2}=106. Moreover, the difference ΔG between the first total axle load value G_{A1} and the second total axle load value G_{A2} is very small (ΔG=106−103=3), because of which it is presumed that the first total axle load value G_{A1} determined via measurements of the axle load measuring system 16 is correct.

In a second plausibility check of the values of the onboard axle load measuring system 16, the device 10, using the numeric values used here, outputs an error message 30 if the first total axle load value G_{A1} determined using the onboard axle load measuring system 16 by measurements is outside the second error interval ΔF₂ of the second total axle load value G_{A2}. This case is illustrated in FIG. 2 by the total axle load value G*_{A1}=112.

Vice versa, a plausibility check of the indirectly determined second total axle load value G_{A2} by the first total axle load value G_{A1} determined via sensory measurements is also possible. In this case, the output of the error message 30 by the device 10 takes place when the second total axle load value G_{A2} is outside the third error interval ΔF₃, which is illustrated in FIG. 2 by the second total axle load value G*_{A2}=117.

According to a method of the disclosure, the following method steps are therefore carried out in succession with the aid of the device 10:
a) determining a first total axle load value G_{A1}, which indicates the value of the total mass m that rests on all vehicle axles,
b) calculating the mass m of the entire vehicle using the formula m=F/a, wherein the value a stands for the current vehicle acceleration and the value F stands for the drive force currently acting on the vehicle 18,
c) calculating a second total axle load value G_{A2} using the formula G_{A2}=(F/a)−m_{FA}, wherein the value m_{FA} stands for the total mass of all considered vehicle axles,
d) comparing the two total axle load values G_{A1}, G_{A2}, and
e) generating an error message 30 if a sufficiently large difference ΔG is established between the first total axle load value G_{A1} and the second total axle load value G_{A2}.

The output of the error message 30 takes place according to the method on the basis of an assessment in consideration of the three error intervals ΔF₁, ΔF₂, ΔF₃ and the total axle load values G_{A1}, G_{A2} as already explained above.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

10 device
16 axle load measuring system of the vehicle
18 vehicle
20 sensor system of the axle load measuring system
24 comparator
26 computing unit
30 error message
32 optical signal generator
34 acoustic signal generator
36 haptic signal generator
38 transmitting and receiving unit on the vehicle
40 stationary transmitting and receiving unit
42 vehicle-external computer
44 event memory
46 interface, CAN bus
48 CAN bus
70 graphic representation
a acceleration of the vehicle
E₁, . . . , E₆ end values of the error intervals
F force, drive force
ΔF₁ first error interval
ΔF₂ second error interval
ΔF₃ third error interval
G_{A1} first total axle load value
G*_{A1} erroneous first total axle load value
G_{A2} second total axle load value
G*_{A2} erroneous second total axle load value
ΔG difference between the total axle load values G_{A1}, G_{A2}
m vehicle total mass including cargo
m₁ first vehicle mass value
m₂ second vehicle mass value
m_{FA} total mass of all vehicle axles
M torque of an output shaft of a vehicle motor
r radius of an output shaft of a vehicle motor

1. A device for checking the plausibility of measured values of an axle load measuring system determinable via a sensor system, wherein the axle load resting on all axles of a vehicle is determinable as a first total axle load value (G_{A1}) using the axle load measuring system, the device comprising:
a comparator;
a computing unit;
said computing unit being configured to compute a second total axle load value (G_{A2});
said comparator being configured to have the first total axle load value (G_{A1}) and the second total axle load value (G_{A2}) supplied thereto;
said comparator being configured to carry out a comparison between the first total axle load value (G_{A1}) and the second total axle load value (G_{A2}); and,
said comparator being configured, if there is a sufficiently large difference (ΔG) between the first total axle load value (G_{A1}) and the second total axle load value (G_{A2}), to at least one of generate an error message and activate a signal generator.

2. The device of claim 1, wherein said computing unit is configured to have a current vehicle acceleration value (a) and a current drive force value (F) acting on the vehicle supplied thereto; and, said computing unit is configured to compute a vehicle total mass (m) including cargo from the current vehicle acceleration value (a) and the current drive force value (F) acting on the vehicle as well as a formula m=F/a; and, said computing unit is configured to compute the second total axle load value (G_{A2}) from the vehicle total mass minus a total mass of all vehicle axles m_{FA}[G_{A2}=(F/a)−m_{FA}].

3. A device for checking the plausibility of measured values of an axle load measuring system determinable via a sensor system, wherein the axle load resting on all axles of a vehicle is determinable as a first total axle load value (G_{A1}) using the axle load measuring system, the device comprising:
a comparator;
a computing unit;
said computing unit being configured to compute a first vehicle mass value (m₁) by addition of the first total axle load value (G_{A1}) and a value of a total mass (m_{FA}) of all vehicle axles (m₁=G_{A1}+m_{FA}),
said computing unit being configured to compute a second vehicle mass value (m₂) including cargo computable via the computing unit from values of a vehicle acceleration (a) and a drive force (F) acting on the vehicle as well as a formula m=F/a;
said comparator being configured to have the first vehicle mass value (m₁) and the second vehicle mass value (m₂) supplied thereto and to carry out a comparison between the first vehicle mass value (m₁) and the second vehicle mass value (m₂); and,
said comparator being further configured, if there is a sufficiently large difference (ΔG) between the first vehicle mass value (m₁) and the second vehicle mass value (m₂), to at least one of generate an error message and activate a signal generator.

4. The device of claim 1 further comprising at least one of an optical signal generator, an acoustic signal generator, and a haptic signal generator for outputting the error message.

5. The device of claim 1 further comprising a wirelessly operating transmitting and receiving unit, via which the error message is transmittable to a wirelessly operating stationary transmitting and receiving unit, which is connected to a vehicle-external computer.

6. The device of claim 1, wherein said comparator is connected to an event memory, in which the error message is storable and from which the error message is retrievable again.

7. A method for checking the plausibility of measured values of an axle load measuring system determinable via a sensor system, using which the axle load resting on all axles of a vehicle is determinable as a first total axle load value (G_{A1}), having the following method steps:
a) determining a first total axle load value (G_{A1}), which indicates a measured value of a mass that rests on all vehicle axles;
b) calculating a vehicle total mass (m) including cargo using the formula m=F/a, wherein the value (a) stands for the current vehicle acceleration and the value (F) stands for the drive force currently acting on the vehicle;
c) calculating a second total axle load value using the formula G_{A2}=(F/a)−m_{FA}, wherein the value m_{FA} stands for the total mass of all considered vehicle axles;
d) comparing the first total axle load value (G_{A1}) and the second total axle load value (G_{A2}); and,
e) generating an error message if a sufficiently large difference (ΔG) is established between the first total axle load value (G_{A1}) and the second total axle load value (G_{A2}).

8. The method of claim 7, wherein the vehicle includes:
a comparator;
a computing unit;
the computing unit being configured to compute the second total axle load value (G_{A2});
the comparator being configured to have the first total axle load value (G_{A1}) and the second total axle load value (G_{A2}) supplied thereto;
the comparator being configured to carry out said comparison between the first total axle load value (G_{A1}) and the second total axle load value (G_{A2}); and,
the comparator is configured, if the sufficiently large difference (ΔG) between the first total axle load value (G_{A1}) and the second total axle load value (G_{A2}) is present, to at least one of generate the error message and activate a signal generator.

9. A method for checking the plausibility of measured values of an axle load measuring system determinable via a sensor system, using which the axle load resting on all axles of a vehicle is determinable as a first total axle load value (G_{A1}), the method comprising:
f) determining a first total axle load value (G_{A1}), which indicates the measured value of a mass that rests on all vehicle axles;
g) calculating a first vehicle mass value (m₁) including cargo by adding the first total axle load value (G_{A1}) to a value (m_{FA}) for a total mass of all considered vehicle axles;
h) calculating a second vehicle mass value (m₂) including cargo using the formula m=F/a, wherein the value (a) stands for the current vehicle acceleration and the value (F) stands for the drive force currently acting on the vehicle;
i) comparing the first vehicle mass value (m₁) and the second vehicle mass value (m₂); and,
j) generating an error message if a sufficiently large difference (ΔG) is established between the first vehicle mass value (m₁) and the second vehicle mass value (m₂).

10. The method of claim 9, wherein the vehicle includes:
a comparator;
a computing unit;
the computing unit being configured to compute the first vehicle mass value (m₁) by addition of the first total axle load value (G_{A1}) and the value of the total mass (m_{FA}) of all vehicle axles (m₁=G_{A1}+m_{FA});
the computing unit being configured to compute the second vehicle mass value (m₂) including cargo computable via the computing unit from values of the vehicle acceleration (a) and the drive force (F) acting on the vehicle as well as the formula m=F/a;
the comparator being configured to have the first vehicle mass value (m₁) and the second vehicle mass value (m₂) supplied thereto and to carry out said comparison between the first vehicle mass value (m₁) and the second vehicle mass value (m₂); and,
the comparator being further configured, if the sufficiently large difference (ΔG) between the first vehicle mass value (m₁) and the second vehicle mass value (m₂) is present, to at least one of generate the error message and activate a signal generator.

11. The method of claim 9, wherein a first error interval (ΔF₁) of at most ±5% is assigned to the first total axle load value (G_{A1}) or the first vehicle mass value (m₁) and a second error interval (Δ_{F2}) of at most ±10% is assigned to the second total axle load value (G_{A2}) or the second vehicle mass value (m₂).

12. The method of claim 11, wherein, upon a plausibility check of the first total axle load value (G_{A1}) or the first vehicle mass value (m₁), an error message is output if the first total axle load value (G_{A1}) or the first vehicle mass value (m₁) is outside the second error interval (Δ_{F2}).

13. The method of claim 9, wherein, upon a plausibility check of the second total axle load value (G_{A2}) or the second vehicle mass value (m₂), an error message is output if the second total axle load value (G_{A2}) or the vehicle mass value (m₂) is outside a third error interval (ΔF3).

14. The method of claim 13, wherein the third error interval (ΔF₃) is computed from the value of the first error interval (ΔF₁) plus the value of the second error interval (ΔF₂).

15. The method of claim 9, wherein the error message is output as at least one of an optical signal, an acoustic signal, and a haptic signal.

16. The method of claim 9, wherein the error message is wirelessly transmitted to a vehicle-external computer.

17. The method of claim 9, wherein the error message is stored in an event memory of the vehicle.

18. The method of claim 7, wherein the error message is stored in an event memory of the vehicle.

19. The method of claim 7, wherein the error message is wirelessly transmitted to a vehicle-external computer.

20. The method of claim 7, wherein the error message is output as at least one of an optical signal, an acoustic signal, and a haptic signal.
